(19) United States
(12) Patent Application Publication
(10) Pub. No.: US 2018/0290693 A1
(43) Pub. Date: Oct. 11, 2018

(54) ADJUSTABLE TAILGATE

(71) Applicants: Clay Ogden, Logan, UT (US); Neil Sessions, Smithfield, UT (US)

(72) Inventors: Clay Ogden, Logan, UT (US); Neil Sessions, Smithfield, UT (US)

(21) Appl. No.: 15/950,163

(22) Filed: Apr. 10, 2018

Related U.S. Application Data
(60) Provisional application No. 62/483,858, filed on Apr. 10, 2017.

(51) Int. Cl. B62D 33/037; B62D 33/03; B62D 33/027

(52) U.S. Cl. CPC B62D 33/037; B62D 33/0273; B62D 33/03

(57) ABSTRACT

An adjustable tailgate apparatus includes a first attachment apparatus configured to attach to a tailgate of a vehicle and a second attachment apparatus configured to attach to a sidewall of the vehicle. The adjustable tailgate apparatus includes a variable span apparatus coupled to the first attachment apparatus and the second attachment apparatus and a locking mechanism configured to restrict movement of the variable span apparatus and constrain a distance between the first attachment apparatus and the second attachment apparatus.

### CROSS-REFENENCE TO RELATED APPLICATIONS

This application claims the benefit of U.S. Provisional Patent Application Ser. No. 62/483,858 filed on Apr. 10, 2017, and entitled “Adjustable Tailgate,” the contents of which are hereby incorporated by reference herein.

### FIELD

This invention relates to an adjustable tailgate and more particularly relates to a locking adjustable angle tailgate.

### BACKGROUND

Hauling cargo or other items that do not fit neatly within a truck bed can be difficult, demanding, and awkward among other things. The positioning of the tailgate may aggravate such difficulties as typical tailgates may only locate between a fully open and fully closed position. Varying the position of the tailgate in a multitude of positions between open and closed may alleviate many of these difficulties. Systems and apparatuses that provide such functionality may be expensive, obtrusive, inadequate, or insufficient to a user's needs. The subject matter of the present application has been developed in response to the present state of the art, and in particular, in response to the shortcomings of tailgates, that have not yet been fully solved by currently available techniques.

### SUMMARY

The subject matter of the present application has been developed in response to the present state of the art, and in particular, in response to the problems and disadvantages associated with conventional fixtures that have not yet been fully solved by currently available techniques. Accordingly, the subject matter of the present application has been developed to provide embodiments of a system, an apparatus, and a method that overcome at least some of the above-discussed shortcomings of prior art techniques.

Disclosed herein is an adjustable tailgate apparatus. The adjustable tailgate apparatus includes a first attachment apparatus configured to attach to a tailgate of a vehicle and a second attachment apparatus configured to attach to a sidewall of the vehicle. The adjustable tailgate apparatus includes a variable span apparatus coupled to the first attachment apparatus and the second attachment apparatus and a locking mechanism configured to restrict movement of the variable span apparatus and constrain a distance between the first attachment apparatus and the second attachment apparatus. The preceding subject matter of this paragraph characterizes example 1 of the present disclosure.

The locking mechanism further includes a toggle. The preceding subject matter of this paragraph characterizes example 2 of the present disclosure, wherein example 2 also includes the subject matter according to example 1, above.

The toggle is configured to switch the locking mechanism between a free mode and a locking mode. The free mode allows for movement between an open and closed position of the tailgate. The locking mode restricts movement of the tailgate. The preceding subject matter of this paragraph characterizes example 3 of the present disclosure, wherein example 3 also includes the subject matter according to any one of examples 1-2, above.

The locking mode restricts movement of the tailgate from a closed position to an open position. The preceding subject matter of this paragraph characterizes example 4 of the present disclosure, wherein example 4 also includes the subject matter according to example 3, above.

The locking mode restricts movement of the tailgate from an open position to a closed position. The preceding subject matter of this paragraph characterizes example 5 of the present disclosure, wherein example 5 also includes the subject matter according to any one of examples 1-4, above.

The locking mode restricts movement of the tailgate from an open position to a closed position and from the closed position to the open position. The preceding subject matter of this paragraph characterizes example 6 of the present disclosure, wherein example 6 also includes the subject matter according to any one of examples 3-5, above.

The toggle is configured to switch the locking mechanism between the free mode and the locking mode manually. The preceding subject matter of this paragraph characterizes example 7 of the present disclosure, wherein example 7 also includes the subject matter according to any one of examples 1-6, above.

The toggle is configured to switch the locking mechanism between the free mode and the locking mode automatically. The preceding subject matter of this paragraph characterizes example 8 of the present disclosure, wherein example 8 also includes the subject matter according to any one of examples 1-7, above.

The toggle is configured to switch automatically when the tailgate locates in a predetermined position. The preceding subject matter of this paragraph characterizes example 9 of the present disclosure, wherein example 9 also includes the subject matter according to any one of examples 1-8, above.

The predetermined position is the closed position. The preceding subject matter of this paragraph characterizes example 10 of the present disclosure, wherein example 10 also includes the subject matter according to any one of examples 1-9, above.

The predetermined position is the open position. The preceding subject matter of this paragraph characterizes example 11 of the present disclosure, wherein example 11 also includes the subject matter according to any one of examples 1-10, above.

The first attachment apparatus is configured to attach to an interior panel of the tailgate of the vehicle. The preceding subject matter of this paragraph characterizes example 12 of the present disclosure, wherein example 12 also includes the subject matter according to any one of examples 1-11, above.

The second attachment apparatus is configured to attach to an interior panel of the sidewall of the vehicle. The preceding subject matter of this paragraph characterizes example 13 of the present disclosure, wherein example 13 also includes the subject matter according to any one of examples 1-12, above.

The variable span apparatus includes a cable and the locking mechanism includes a spool. The preceding subject matter of this paragraph characterizes example 14 of the present disclosure, wherein example 14 also includes the subject matter according to any one of examples 1-13, above.

The variable span apparatus includes a serrated shaft and the locking mechanism includes a plurality of spring actuated pawls. The preceding subject matter of this paragraph characterizes example 15 of the present disclosure, wherein example 15 also includes the subject matter according to any one of examples 1-14, above.

The locking mechanism is coupled to the second attachment apparatus. The preceding subject matter of this paragraph characterizes example 16 of the present disclosure, wherein example 16 also includes the subject matter according to any one of examples 1-15, above.

The locking mechanism includes a cogwheel housing and variable span apparatus includes a strap. The preceding subject matter of this paragraph characterizes example 17 of the present disclosure, wherein example 17 also includes the subject matter according to any one of examples 1-16, above.

The locking mechanism further includes a plurality of pawls, the pawls are configured to engage a plurality of teeth on the cogwheel housing, and the pawls are configured to restrict rotation of the cogwheel housing in a first direction of rotation and permit rotation of the cogwheel housing in a second direction of rotation. The preceding subject matter of this paragraph characterizes example 18 of the present disclosure, wherein example 18 also includes the subject matter according to any one of examples 1-17, above.

A first end of the strap is coupled to the cogwheel housing and a second end of the strap is coupled to the sidewall of the vehicle. The preceding subject matter of this paragraph characterizes example 19 of the present disclosure, wherein example 19 also includes the subject matter according to any one of examples 1-18, above.

The variable span apparatus includes at least two rigid members configured to rotate relative to each other. The preceding subject matter of this paragraph characterizes example 20 of the present disclosure, wherein example 20 also includes the subject matter according to any one of examples 1-19, above.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of a truck with an adjustable tailgate apparatus, according to one or more embodiments of the present disclosure;

FIG. 2 is a perspective view of a truck with an adjustable tailgate apparatus, according to one or more embodiments of the present disclosure;

FIG. 3 is a top view of an adjustable tailgate apparatus, according to one or more embodiments of the present disclosure;

FIG. 4 is a side view of an adjustable tailgate apparatus, according to one or more embodiments of the present disclosure;

FIG. 5 is a detail side view of a cutaway of a locking mechanism of an adjustable tailgate apparatus, according to one or more embodiments of the present disclosure;

FIG. 6 is a side view of an adjustable tailgate apparatus, according to one or more embodiments of the present disclosure;

FIG. 7 is a detail front view of a cutaway of a locking mechanism of an adjustable tailgate apparatus, taken along the line B-B of FIG. 6, according to one or more embodiments of the present disclosure;

FIG. 8 is a side view of a mounting hub, according to one or more embodiments of the present disclosure;

FIG. 9 is a front view of a mounting hub, according to one or more embodiments of the present disclosure;

FIG. 10 is a side view of a locking mechanism housing, according to one or more embodiments of the present disclosure;

FIG. 11 is a front view of a locking mechanism housing, according to one or more embodiments of the present disclosure;

FIG. 12 is a side view of a front plate for a locking mechanism housing, according to one or more embodiments of the present disclosure;

FIG. 13 is a side view of a pawl, according to one or more embodiments of the present disclosure;

FIG. 14 is a front view of a pawl, according to one or more embodiments of the present disclosure;

FIG. 15 is a perspective view of a reset button of a locking mechanism, according to one or more embodiments of the present disclosure;

FIG. 16 is a side view of a reset button of a locking mechanism, according to one or more embodiments of the present disclosure;

FIG. 17 is a front view of a reset button of a locking mechanism, according to one or more embodiments of the present disclosure;

FIG. 18 is a top view of a slider of a locking mechanism, according to one or more embodiments of the present disclosure;

FIG. 19 is a side view of a slider of a locking mechanism, according to one or more embodiments of the present disclosure;

FIG. 20 is a front view of a torsion spring of a locking mechanism, according to one or more embodiments of the present disclosure;

FIG. 21 is a front view of a mounting plate, according to one or more embodiments of the present disclosure;

FIG. 22 is a side view of a mounting plate, according to one or more embodiments of the present disclosure;

FIG. 23 is a schematic diagram of an adjustable tailgate apparatus, according to one or more embodiments of the present disclosure;

FIG. 24 is a schematic diagram of an adjustable tailgate apparatus, according to one or more embodiments of the present disclosure;

FIG. 25 is an exploded perspective view of a locking mechanism and variable span apparatus, according to one or more embodiments of the present disclosure; and

FIG. 26 is an exploded perspective view of a locking mechanism and variable span apparatus, according to one or more embodiments of the present disclosure.

### DETAILED DESCRIPTION

The subject matter of the present application has been developed in response to the present state of the art, and in particular, in response to the shortcomings of tailgates, that have not yet been fully solved by currently available techniques. Accordingly, the subject matter of the present application has been developed to provide an adjustable tailgate apparatus, which overcomes at least some of the shortcomings of prior art techniques.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

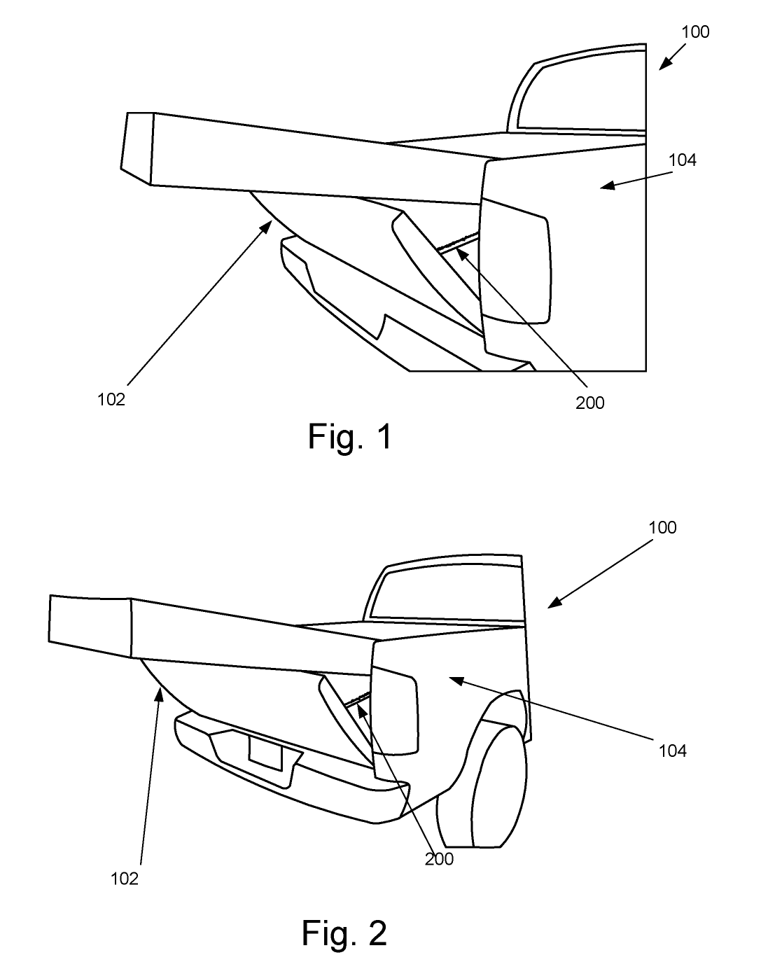

Referring to FIGS. 1 and 2, a perspective view of a truck 100 with an adjustable tailgate apparatus 200 is shown. In the illustrated embodiment the adjustable tailgate apparatus 200 is attached to a tailgate 102 and a sidewall 104 of a truck bed. The adjustable tailgate apparatus 200 includes a first attachment apparatus, a second attachment apparatus, a variable span apparatus, and a locking mechanism. Although the adjustable tailgate apparatus 200 is shown and described with certain components and functionality, other embodiments of the adjustable tailgate apparatus 200 may include fewer or more components to implement less or more functionality.

In some embodiments, the adjustable tailgate apparatus 200 is attached to the truck 100 as an aftermarket system. In some embodiments, the adjustable tailgate apparatus 200 is integrated into the design of the truck 100 with an original equipment manufacturer (OEM). In some embodiments, a truck 100 may include a single adjustable tailgate apparatus 200. In some embodiments, a truck 100 may include two adjustable tailgate apparatuses 200 on each side of the tailgate 102.

The first attachment apparatus attaches to the tailgate 102 of a truck. The first attachment apparatus may attach at various positions on or within the tailgate 102. In some embodiments, the first attachment apparatus attaches on an external surface on the tailgate 102. In some embodiments, the first attachment apparatus attaches to an interior panel (relative to the truck bed) of the tailgate 102. In some embodiments, the first attachment apparatus attaches to an external panel (relative to the truck bed) of the tailgate 102. In some embodiments, the first attachment apparatus attaches to a side panel of the tailgate 102. In some embodiments, the first attachment apparatus attaches to the top of the tailgate 102 on a tailgate cap. In some embodiments, the first attachment apparatus attaches at a location internal to the tailgate 102 and the adjustable tailgate apparatus 200 extends through an opening on the tailgate 102. In some embodiments, the first attachment apparatus attaches at one of various positions along the length of the tailgate 102. The first attachment apparatus may include any of a number of fastening hardware including, but not limited to, bolts, flanges, screws, glue, clips, pins, ties, nails, magnets, velcro etc.

The second attachment apparatus attaches to the sidewall 104 of a truck. The second attachment apparatus may attach at various positions on or within the sidewall 104. In some embodiments, the second attachment apparatus attaches on an external surface on the sidewall 104. In some embodiments, the second attachment apparatus attaches to an interior panel (relative to the truck bed) of the sidewall 104. In some embodiments, the second attachment apparatus attaches to an exterior panel (relative to the truck bed) of the sidewall 104. In some embodiments, the second attachment apparatus attaches to a side panel of the sidewall 104 at the rear of the truck. In some embodiments, the second attachment apparatus attaches to a top surface of the sidewall 104. In some embodiments, the second attachment apparatus attaches at a location internal to the sidewall 104 and the adjustable tailgate apparatus 200 extends through an opening on the sidewall 104. The second attachment apparatus may include any of a number of fastening hardware including, but not limited to, bolts, flanges, screws, glue, clips, pins, ties, nails, etc.

The adjustable tailgate apparatus 200 includes a variable span apparatus which varies the distance between the first attachment apparatus and the second attachment apparatus and thus varies the angle of the tailgate 102 between a fully closed position (i.e., perpendicular to the truck bed or vertical relative to the ground) and a fully open position (i.e., parallel to the truck bed or horizontal relative to the ground). Although tailgates 102 typically rotate 90 degrees from a fully closed position to a fully open position, embodiments of the invention encompass larger spans between a fully closed position and a fully open position. For example, embodiments include systems and apparatuses that function on tailgates that open past ninety degrees and/or all the way to the ground. For simplicity, the disclosure herein discusses typical tailgate 102 positions. The variable span apparatus varies the distance between the first attachment apparatus and the second attachment apparatus. In some embodiments, the distance may vary in discrete increments. In some embodiments, the distance may vary continuously. The variable span apparatus may include any of a number of hardware including, but not limited to, a serrated shaft, screw shaft, cable, strap, spool, rigid folding members, telescoping shaft, hydraulic or pneumatic actuated shafts or cables, etc.

The adjustable tailgate apparatus 200 includes a locking mechanism which locks the variable span apparatus and thus the distance between the first attachment apparatus and the second attachment apparatus. The locking mechanism allows the tailgate 102 to be positioned and held in place at various locations between fully closed and fully open. In the illustrated embodiment depicted in FIG. 1, the tailgate 102 is locked at an angle approximately 45 degrees from parallel to the ground. The tailgate 102 may be positioned at various angles between 0 and 90 degrees from parallel to the ground by adjusting the variable span apparatus. Embodiments of the invention allow for a truck to haul items that are longer than the truck bed without leaving the tailgate 102 in a fully open position. This allows a user to change the fulcrum point of long items being hauled in a truck. As depicted in FIG. 1, the angle at which the wood beams rest in the truck bed may be adjusted by adjusting the fulcrum point (the resting position on the tailgate 102). Embodiments are especially advantageous for hauling motorcycles which may be slightly longer than the length of a truck bed by allowing the tailgate to rise to a position that engages the tire of the motorcycle and thus restricts movement of the motorcycle.

The locking mechanism may be placed at various locations on the adjustable tailgate apparatus 200. In some embodiments, the locking mechanism is located near the first attachment apparatus on the tailgate 102. In some embodiments, the locking mechanism is located near the second attachment apparatus on the sidewall 104. In some embodiments, the locking mechanism is located between the first attachment apparatus and the second attachment apparatus at a point along the variable span apparatus.

In some embodiments, the locking mechanism includes a free mode and a locking mode. The free mode allows for the tailgate 102 to freely move between open and closed as well as between closed and open by allowing the variable span apparatus to adjust the distance between the first and second attachment apparatuses. The locking mode will restrict movement of the tailgate in one or both directions. For example, in the locking mode, the locking mechanism will allow for the tailgate 102 to move freely from open to closed but will restrict the tailgate 102 from moving in a direction from closed to open. In another example, the locking mechanism will allow for the tailgate 102 to move freely from closed to open but will restrict the tailgate 102 from moving in a direction from open to closed. The locking mechanism may control and/or lock the variable span apparatus in any of a number of ways including, but not limited to, mechanically, electrically, hydraulically, pneumatically, or magnetically.

In some embodiments, the locking mechanism includes a toggle which may include a switch, button, lever, control, knob etc. that is configured to switch the locking mechanism between the free mode and the locking mode. In some embodiments, the toggle is activated manually allowing for a user to utilize the adjustable tailgate apparatus 200 only at times when it is convenient. In some embodiments, the toggle toggles automatically when the tailgate 102 locates in a certain position. In some embodiments, the toggle automatically toggles to free mode when the tailgate 102 is closed. In some embodiments, the toggle automatically toggles to locking mode when the tailgate 102 is closed. In some embodiments, the toggle automatically toggles to free mode when the tailgate 102 is fully opened. In some embodiments, the toggle automatically toggles to locking mode when the tailgate 102 is fully opened. In addition, the toggle may be customized to a user's desires. The toggle may be configured to automatically toggle to either free mode or locking mode at any position of the tailgate 102 desired by the user.

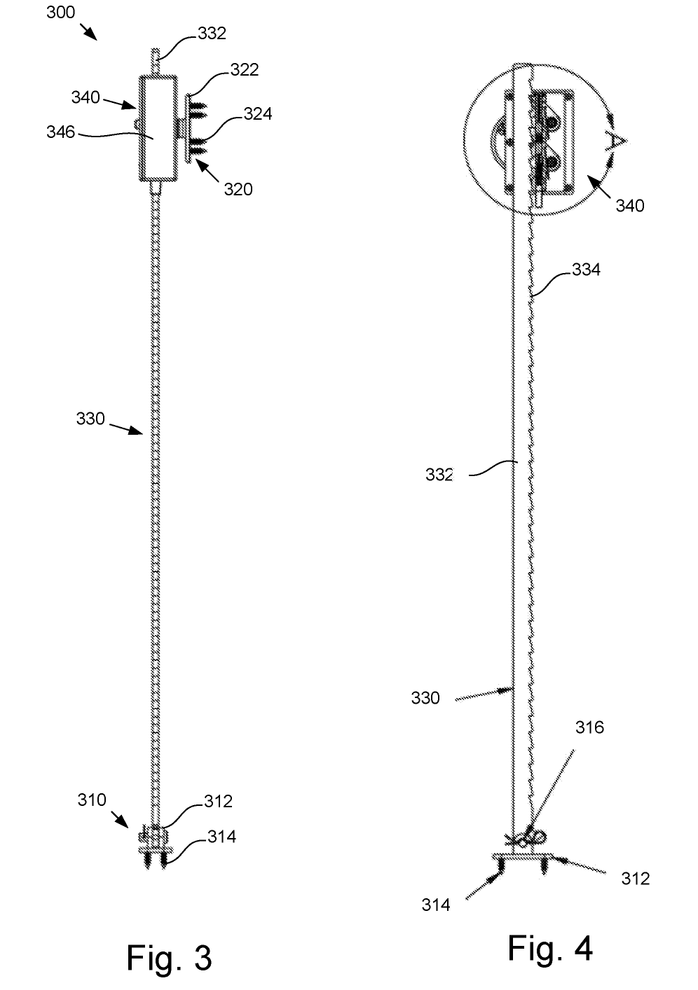

Referring to FIGS. 3-7, an adjustable tailgate apparatus 300, according to one or more embodiments of the present disclosure, is shown. The adjustable tailgate apparatus 300 includes a first attachment apparatus 310, a second attachment apparatus 320, a variable span apparatus 330, and a locking mechanism 340.

Although the adjustable tailgate apparatus 300 is shown and described with certain components and functionality, other embodiments of the adjustable tailgate apparatus 300 may include fewer or more components to implement less or more functionality. In addition, the adjustable tailgate apparatus 300 may include some or all of the features discussed above in conjunction with the adjustable tailgate apparatus 200 of FIGS. 1 and 2.

The first attachment apparatus 310 attaches to an interior panel of the tailgate 102 of the truck 100. The first attachment apparatus 310 includes a mounting plate 312 and attachment screws 314 for attaching the mounting plate 312 to the tailgate 102. The mounting plate 312 interfaces with and attaches to the variable span apparatus 330 and allows rotation of the variable span apparatus 330 about one axis and restricts all other movement between the variable span apparatus 330 and the mounting plate 312. Although the first attachment apparatus 310 is shown and described with certain components and functionality, other embodiments of the first attachment apparatus 310 may include fewer or more components to implement less or more functionality. The first attachment apparatus 310 may include any of a number of fastening hardware including, but not limited to, bolts, flanges, screws, glue, clips, pins, ties, nails, etc. and further may attach to the tailgate 102 in any of a number other locations on or within the tailgate 102.

The second attachment apparatus 320 attaches to an interior panel of the sidewall 104 of the truck 100. The second attachment apparatus 320 includes a mounting hub 322 and attachment screws 324 for attaching the mounting hub 322 to the sidewall 104. Although the second attachment apparatus 320 is shown and described with certain components and functionality, other embodiments of the second attachment apparatus 320 may include fewer or more components to implement less or more functionality. The second attachment apparatus 320 may include any of a number of fastening hardware including, but not limited to, bolts, flanges, screws, glue, clips, pins, ties, nails, etc. and further may attach to the sidewall 104 in any of a number other locations on or within the sidewall 104.

The mounting hub 322 interfaces and attaches to the locking mechanism 340 and allows rotation of the locking mechanism 340 about one axis. The locking mechanism 340 attaches to the mounting hub 322 by a bolt 372 which extends through a bearing 374 that allows for the rotation (see, e.g., FIG. 7). A washer 376 is located between the mounting hub 322 and the locking mechanism 340.

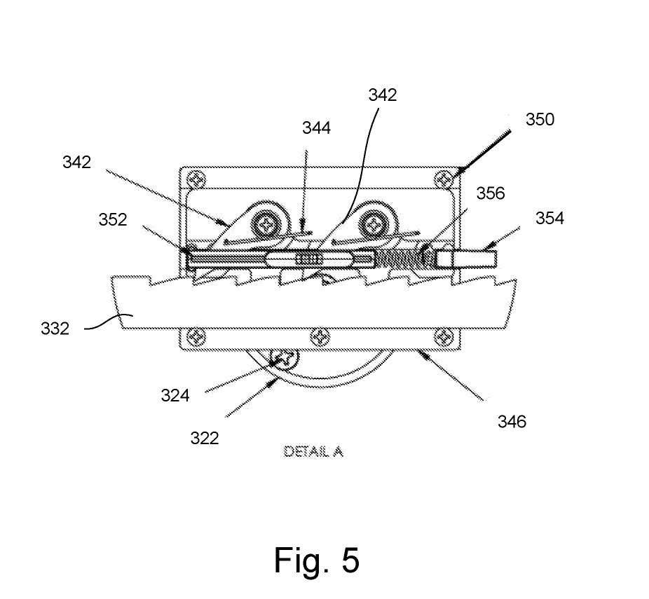

The variable span apparatus 330 includes a shaft 332 which extends between the first attachment apparatus 310 and the locking mechanism 340 (and thus the second attachment apparatus 320). The shaft 332 attaches to the mounting plate 312 through a bolt and cotter pin 316. The bolt and cotter pin 316 allows rotation of the shaft 332 about the bolt's longitudinal axis and restricts all other movement between the shaft 332 and the mounting plate 312. The shaft 332 includes serrations 334 which interact with the locking mechanism 340 and more specifically pawls 342 which are biased by torsion springs 344 to engage the serrations 334 and allow the shaft 332 to move through the locking mechanism 340 in one direction and restrict movement in the opposite direction. For example, referring to FIG. 5 (a detailed internal view of the locking mechanism), the pawls 342 allow for free movement of the shaft 332 in a direction from right to left through the locking mechanism 340 but restrict the shaft 332 from moving in a direction from left to right through the locking mechanism 340. Although the depicted embodiment includes a serrated shaft 332 any of a number of hardware capable of lengthening and/or shortening the distance between the first and second attachment apparatuses may be utilized including, but not limited to, screw shaft, cable, strap, spool, rigid folding members, telescoping shaft, hydraulic or pneumatic actuated shafts or cables, etc.

The locking mechanism 340 includes a housing 346 and a front plate 348 which may be fastened together by screws 350 and which together house the various internal components of the locking mechanism 340. The locking mechanism 340 is configured to lock the positioning of the variable span apparatus and restrict the tailgate 102 from opening further. This may be done by any of a number of ways within the scope of embodiments of the invention including, but not limited to, restricting the rotation of a spool (for a cable and spool apparatus), restricting the rotation of a screwed shaft, restricting linear motion of a serrated shaft, restricting the telescoping of a telescoping rod. Restricting motion may be accomplished mechanically or by electronic gear not specifically outlined herein. For example, a step motor or other electronic motors may restrict motion and function as part of the locking mechanism. The controls for such electronic gear may be placed on the adjustable tailgate apparatus 300 or within the cab of the truck or other locations on the truck. Additionally, such controls may be controlled remotely in some embodiments.

The locking mechanism 340 further includes a slider 352, a reset button 354, and a compression spring 356. The slider 352, reset button 354, and compression spring 356 function together as a toggle between the free mode and the locking mode. The slider includes a knob which extends through and out the front plate 348 and which can be manually moved between a first and second position. With the slider in the second position will allow the pawls 342 to engage the serrations 334 and thus the locking mechanism 340 will be in a locking mode. With the slider in the first position, the pawls 342 are disengaged from the serrations 334 and thus the locking mechanism 340 will be in a free mode. The reset button 354 and compression spring 356 may be engaged to reset the slider 352 to the first position and thus allow the tailgate 102 freedom of movement in either direction until the slider is moved to the second position with the locking mechanism 340 in locking mode. The reset button 354 may be engaged manually by a user or may be automatically engaged based on the positioning of the tailgate 102. For example, the reset button 354 may be configured to be automatically engaged when the tailgate 102 is closed. Although the toggle is described with a slider 352, reset button 354, and compression spring 356, other embodiments of the toggle may include fewer or more components to implement less or more functionality. The toggle may be accomplished in any of a number of ways to engage and disengage the locking mechanism and toggle between a free mode and a locking mode.

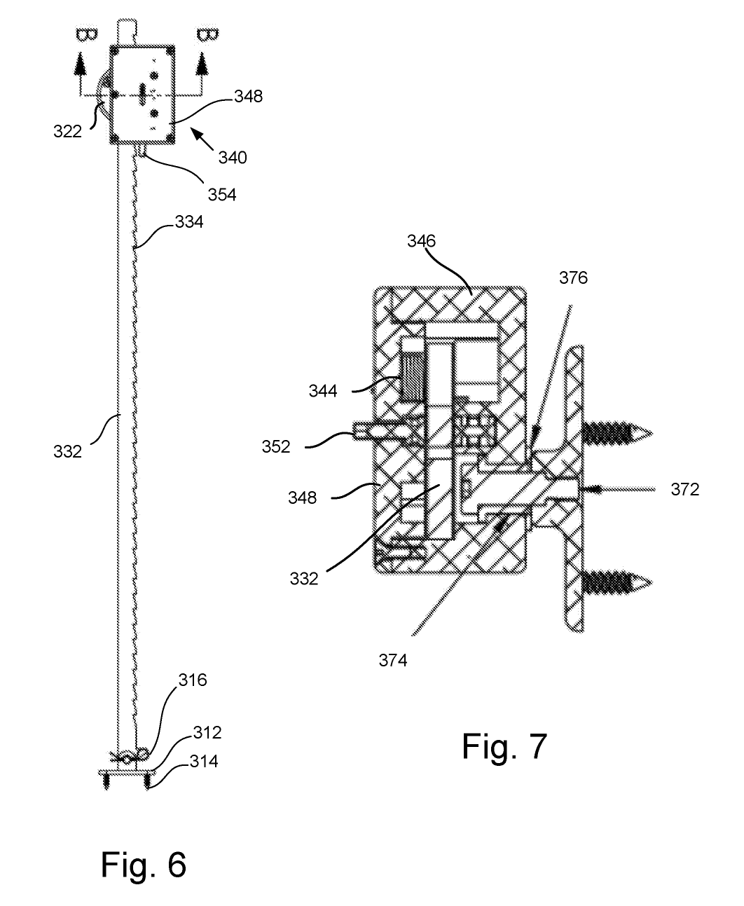

FIG. 3 is a top view of an adjustable tailgate apparatus 300. FIG. 4 is a side view of an adjustable tailgate apparatus 400 with the front plate 348 removed and depicting the internal components of the locking mechanism 340. FIG. 5 is a detail side view of the locking mechanism 340 with the front plate 348 removed and depicting the internal components of the locking mechanism 340. FIG. 6 is a side view of the adjustable tailgate apparatus 300. FIG. 7 is a detail front view of a cutaway of a locking mechanism 340, taken along the line B-B of FIG. 6.

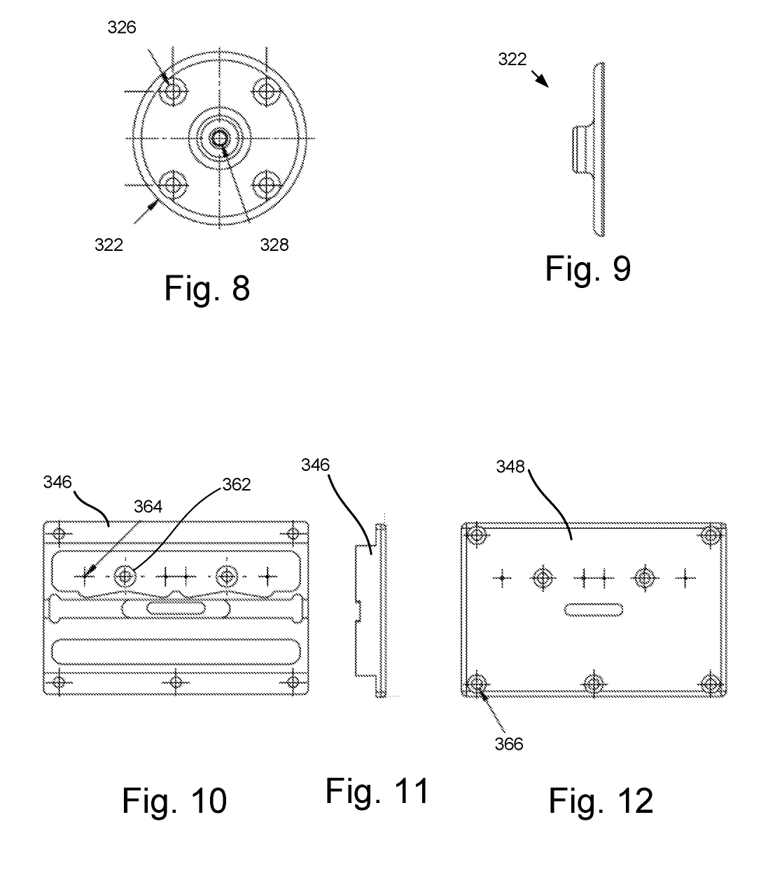

FIG. 8 is a side view of a mounting hub 322. The mounting hub 322 includes four through holes 326 through which the mounting hub 322 may be attached to the sidewall 104 of the truck 100. The mounting hub 322 includes a center through hole 328 at which the locking mechanism 340 may be attached to the mounting hub 322. FIG. 9 is a front view of a mounting hub 322.

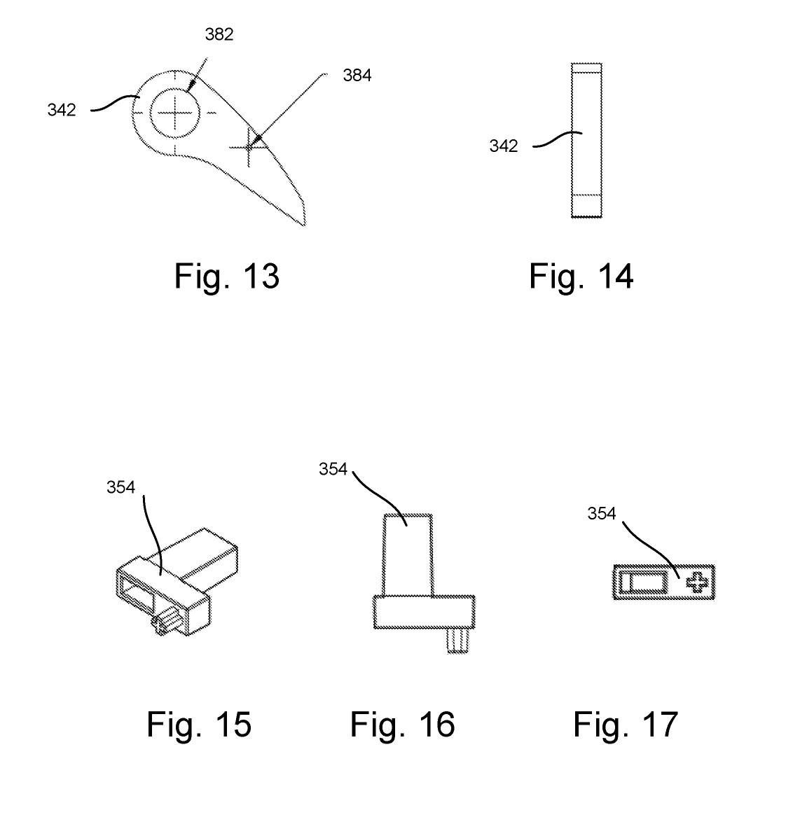

FIG. 10 is a side view of the locking mechanism housing 346. FIG. 11 is a front view of a locking mechanism housing 346. The housing 346 includes a pawl engagement area 362 and a torsion spring engagement area 364. FIG. 12 is a side view of the front plate 348 and includes through holes 366 for fastening the front plate 348 to the housing 346. FIG. 13 is a side view of the pawl 342 and FIG. 14 is a front view of the pawl 342. The pawl 342 includes a through hole 382 which allows for the pawl 342 to be fastened to the housing 346. The pawl 342 further includes a through hole 384 through which the torsion spring 344 engages the pawl 342 and biases the rotation of the pawl 342.

FIG. 15 is a perspective view of the reset button 354, FIG. 16 is a side view of the reset button 354, and FIG. 17 is a front view of the reset button 354.

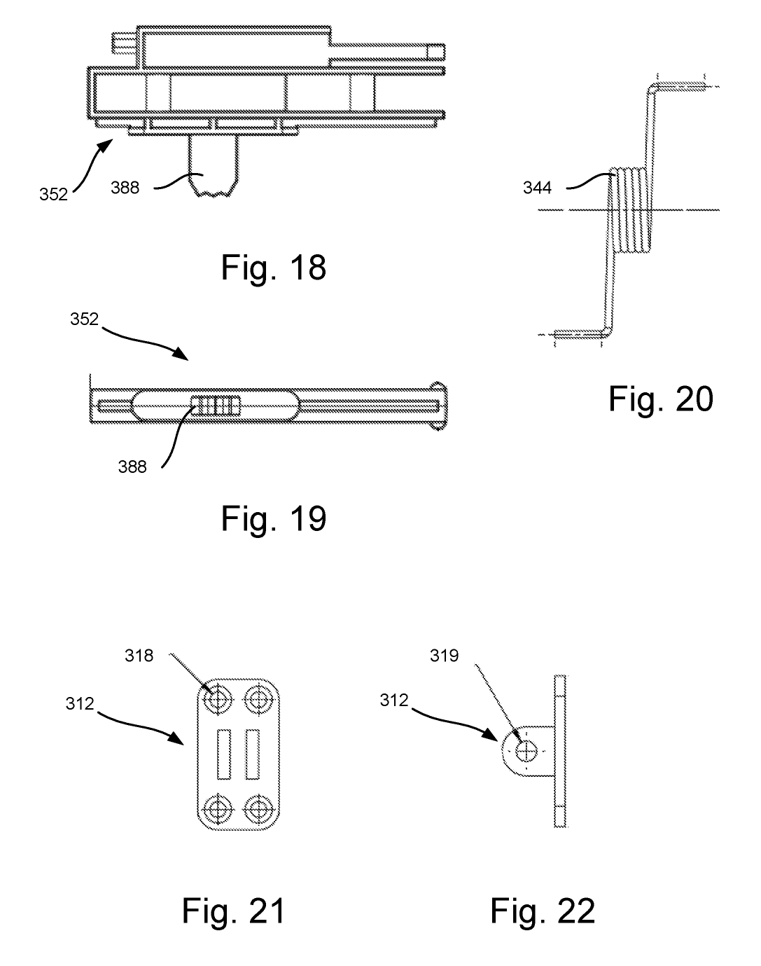

FIG. 18 is a top view of the slider 352 and FIG. 19 is a side view of the slider 352. The slider includes a knob 388 and various other features with engage the other internal components of the locking mechanism 340.

FIG. 21 is a front view of the mounting plate 312 and FIG. 22 is a side view of the mounting plate 312. The mounting plate 312 includes four through holes 318 through which the mounting plate 312 may be attached to the tailgate 102. The mounting plate 312 further includes a through holes 319 through which the bolt and cotter pin 316 may attach the shaft 332 to the mounting plate.

FIG. 23 is a schematic diagram of an embodiment of an adjustable tailgate apparatus 400. The adjustable tailgate apparatus 400 includes some components similar to, the same as, or equivalent to the components described above. The adjustable tailgate apparatus 400 includes two rigid members, one of which attaches to the tailgate of the truck with the other attaching to the sidewall of the truck. In some embodiments, the rigid members coupled to the tailgate and the sidewall of the truck attachment apparatuses as described herein. In some embodiments, the adjustable tailgate apparatus 400 includes a locking mechanism including a mechanical gear system (depicted schematically by the circle). The mechanical gear system is configured to rotate the two rigid members relative to each other and adjust the tailgate to various positions between open and closed. The adjustable tailgate apparatus 400 may include all, some, or none of the features described above in conjunction the various other embodiments described and their equivalents.

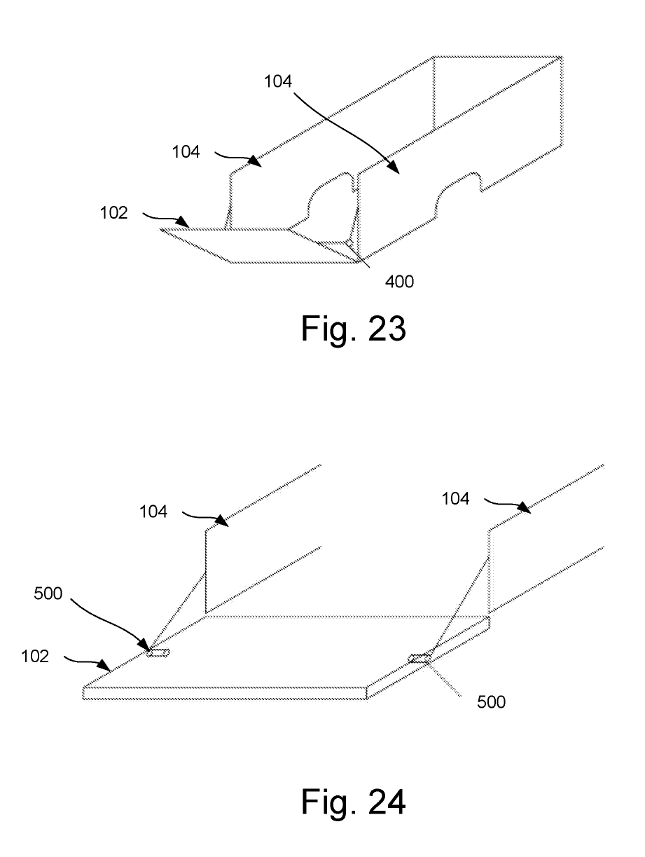

FIG. 24 is a schematic diagram of another embodiment of an adjustable tailgate apparatus 500. The adjustable tailgate apparatus 500 includes some components similar to, the same as, or equivalent to the components described above in conjunction with other embodiments of an adjustable tailgate apparatus. The adjustable tailgate apparatus 500 includes a cable which attaches to the sidewall of the truck and spools up in a receiver (depicted schematically by the cylinder within the tailgate). In some embodiments, the adjustable tailgate apparatus 500 includes locking mechanism. In some embodiments, the receiver is the locking mechanism. In some embodiments, the adjustable tailgate apparatus 500 includes a variable span apparatus. In some embodiments, the variable span apparatus is the cable. The adjustable tailgate apparatus 500 may include all, some, or none of the features described above with the various other embodiments described and their equivalents.

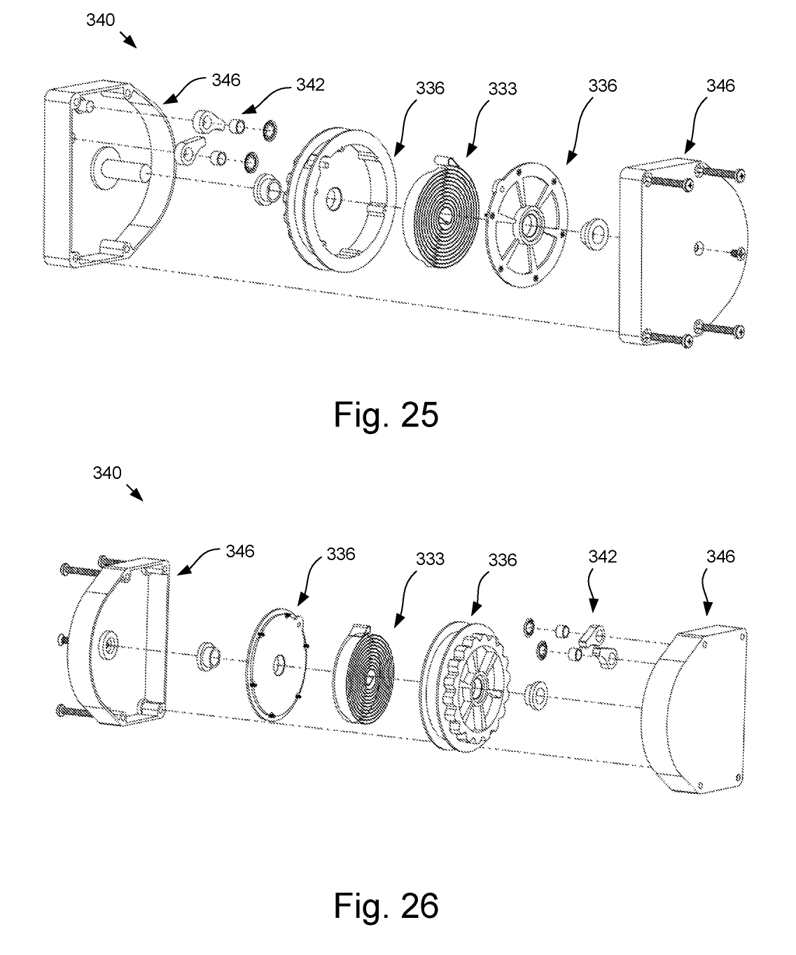

FIG. 25 is an exploded perspective view of a locking mechanism 340 and variable span apparatus 330. The locking mechanism 340 and the variable span apparatus employ a cable or strap 333 as part of the variable span apparatus 330. The variable span apparatus 330 includes a cogwheel housing 336. The teeth of the cogwheel housing 336 engage pawls 342 which allow the cogwheel housing 336 to freely rotate in one direction and restrict the cogwheel housing 336 from rotating in an opposite direction. As the cogwheel housing 336 rotates the cable or strap 333 winds and unwinds. One end of the cable or strap 333 is secured to the cogwheel housing 336 while an opposite end of the cable or strap 333 is secured to an attachment apparatus secured to either the tailgate or the vehicle. FIG. 26 is an exploded perspective view of an opposite side of the locking mechanism 340 and variable span apparatus 330. Although not shown, the embodiments of FIGS. 25 and 26 may includes some or all the features described and depicted in the other embodiments described herein.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An adjustable tailgate apparatus comprising:
a first attachment apparatus configured to attach to a tailgate of a vehicle;
a second attachment apparatus configured to attach to a sidewall of the vehicle;
a variable span apparatus coupled to the first attachment apparatus and the second attachment apparatus; and
a locking mechanism configured to restrict movement of the variable span apparatus and constrain a distance between the first attachment apparatus and the second attachment apparatus.

2. The adjustable tailgate apparatus according to claim 1, wherein the locking mechanism further comprises a toggle.

3. The adjustable tailgate apparatus according to claim 2, wherein:
the toggle is configured to switch the locking mechanism between a free mode and a locking mode;
the free mode allows for movement between an open and closed position of the tailgate;
the locking mode restricts movement of the tailgate.

4. The adjustable tailgate apparatus according to claim 3, wherein the locking mode restricts movement of the tailgate from a closed position to an open position.

5. The adjustable tailgate apparatus according to claim 3, wherein the locking mode restricts movement of the tailgate from an open position to a closed position.

6. The adjustable tailgate apparatus according to claim 3, wherein the locking mode restricts movement of the tailgate from an open position to a closed position and from the closed position to the open position.

7. The adjustable tailgate apparatus according to claim 3, wherein the toggle is configured to switch the locking mechanism between the free mode and the locking mode manually.

8. The adjustable tailgate apparatus according to claim 3, wherein the toggle is configured to switch the locking mechanism between the free mode and the locking mode automatically.

9. The adjustable tailgate apparatus according to claim 8, wherein the toggle is configured to switch automatically when the tailgate locates in a predetermined position.

10. The adjustable tailgate apparatus according to claim 9, wherein the predetermined position is the closed position.

11. The adjustable tailgate apparatus according to claim 9, wherein the predetermined position is the open position.

12. The adjustable tailgate apparatus according to claim 1, wherein the first attachment apparatus is configured to attach to an interior panel of the tailgate of the vehicle.

13. The adjustable tailgate apparatus according to claim 1, wherein the second attachment apparatus is configured to attach to an interior panel of the sidewall of the vehicle.

14. The adjustable tailgate apparatus according to claim 1, wherein the variable span apparatus comprises a cable and the locking mechanism comprises a spool.

15. The adjustable tailgate apparatus according to claim 1, wherein the variable span apparatus comprises a serrated shaft and the locking mechanism comprises a plurality of spring actuated pawls.

16. The adjustable tailgate apparatus according to claim 15, wherein the locking mechanism is coupled to the second attachment apparatus.

17. The adjustable tailgate apparatus according to claim 1, wherein:
the locking mechanism comprises a cogwheel housing; and
the variable span apparatus comprises a strap.

18. The adjustable tailgate apparatus according to claim 17, wherein:
the locking mechanism further comprises a plurality of pawls;
the pawls are configured to engage a plurality of teeth on the cogwheel housing; and
the pawls are configured to restrict rotation of the cogwheel housing in a first direction of rotation and permit rotation of the cogwheel housing in a second direction of rotation.

19. The adjustable tailgate apparatus according to claim 18, wherein a first end of the strap is coupled to the cogwheel housing and a second end of the strap is coupled to the sidewall of the vehicle.

20. The adjustable tailgate apparatus according to claim 1, wherein the variable span apparatus comprises at least two rigid members configured to rotate relative to each other.
